(19) United States
(12) Patent Application Publication
(10) Pub. No.: US 2009/0256866 A1
(43) Pub. Date: Oct. 15, 2009

(54) IMAGE DISPLAY APPARATUS

(75) Inventor: Takeshi Noda, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/415,296

(22) Filed: Mar. 31, 2009

(30) Foreign Application Priority Data
Apr. 14, 2008 (JP) 2008-104646

(51) Int. Cl. G09G 5/10

(52) U.S. Cl. 345/690

(57) ABSTRACT

An image display apparatus including: a plurality of display elements; a drive circuit for driving the plurality of display elements, the drive circuit having a correction circuit for correcting, in response to a gradation, variations of luminance characteristics of the plurality of display elements, wherein the drive circuit outputs modulation signals such that a modulation signal for a first gradation and a modulation signal for a second gradation are of similar shape, and wherein the correction circuit corrects the first gradation using a value derived from a luminance characteristic of the display element that is measured by driving the display element with the modulation signal for the second gradation.

### BACKGROUND OF THE INVENTION

1. Field of the Invention

The present invention relates to an image display apparatus, and particularly relates to an image display apparatus using a passive matrix drive.

2. Description of the Related Art

Image display apparatuses with the use of a liquid crystal display apparatus, a plasma display apparatus, an EL display apparatus and an electron-emitting device are known as a flat-type image display apparatus which substitutes for a CRT.

Electron-emitting devices of a field emission type, an MIM type and a surface-conduction type are known as an electron-emitting device for an image display apparatus with the use of the electron-emitting device.

These image display apparatuses display an image by matrix-driving a plurality of display elements. Therefore, each display element can have uniform luminance characteristics.

However, process variations of several percent to several tens percent are occasionally formed in the display element due to the ununiformity of a manufacturing process or the like for the display element. Therefore, variations of luminance characteristics occasionally occur among each display element. The variation of the luminance (luminance characteristics) does not necessarily have a linear relationship with respect to an voltage applied to the display element and/or an electric current following through the display element.

Japanese Patent Application Laid-Open No. 2000-122598 proposes a structure having a correction table with respect to all gradations of each of the display elements so as to compensate the variations of the luminance characteristics among each display element.

However, the structure in Japanese Patent Application Laid-Open No. 2000-122598 has a problem that when the number of the display elements or the number of the gradations increases, memory capacities become enormous amounts. The structure also has a problem that a long period of time is needed to measure the luminance in a low gradation side with high accuracy. Actually, when the luminance is measured by a luminance meter, it needs two to three times longer exposure time than that for the luminance of 100 cd/m² to measure the luminance of 0.1 cd/m² or less with enhanced accuracy.

Therefore, it is practically difficult to employ a structure having a correction table for all gradations of each of display elements.

In contrast, a leaflet of the International Publication No. WO 2005/124734 proposes a structure which has a correction data for a plurality of gradations (luminance correction point) of each of the display elements, and in which correction data for gradations between the luminance correction points are determined with an interpolation method.

Here, impedance such as modulation wire resistance, intersection capacity between modulation wires and scan wires and parasitic capacity of a display element generally exists in the display element and wiring, and occasionally a distortion of a waveform occurs due to the above impedances.

FIGS. 1A and 1B are views illustrating a distortion of a waveform of a modulation signal in a pulse-width modulation system. A solid line shows a modulation signal in a low gradation, and a dotted line shows a modulation signal in a high gradation. FIG. 1A illustrates an ideal modulation signal when a waveform is not distorted. FIG. 1B illustrates a practical modulation signal in which the waveform is distorted.

Generally, the modulation signal in the low gradation is more largely affected by the distortion of the waveform than the modulation signal in the high gradation. Therefore, if the luminance of the low gradation is corrected with the use of a correction value which has been determined by measuring the luminance of the high gradation, the corrected value has an error due to the distortion of the waveform, and occasionally forms a linear streak irregularity.

### SUMMARY OF THE INVENTION

The present invention is directed to providing an image display apparatus which can correct variations of luminance characteristics of a display element with high accuracy.

An image display apparatus including: a plurality of display elements; a drive circuit for driving the plurality of display elements, the drive circuit having a correction circuit for correcting, in response to a gradation, variations of luminance characteristics of the plurality of display elements, wherein the drive circuit outputs modulation signals such that a modulation signal for a first gradation and a modulation signal for a second gradation are of similar shape, and wherein the correction circuit corrects the first gradation using a value derived from a luminance characteristic of the display element that is measured by driving the display element with the modulation signal for the second gradation.

The image display apparatus according to the present invention can correct the variations of the luminance characteristics of the display element with high accuracy.

Further features of the present invention will become apparent from the following description of exemplary embodiments with reference to the attached drawings.

### BRIEF DESCRIPTION OF THE DRAWINGS

FIGS. 1A and 1B are views illustrating a distortion of a waveform of a modulation signal in a pulse-width modulation system.

FIG. 2 is a view describing a structure of an image display apparatus in which electron-emitting devices are arrayed in a matrix form.

FIG. 3 is a view illustrating a drive circuit.

FIG. 4 is a view illustrating a waveform of a modulation signal in a first embodiment.

FIG. 5 is a view illustrating a waveform of a modulation signal in a second embodiment.

FIG. 6 is a view illustrating a waveform of a modulation signal in a third embodiment.

FIG. 7 is a view illustrating an equivalent circuit of a display element according to the present invention.

FIG. 8 is a view illustrating a waveform of a scan signal in the present exemplary embodiment.

FIGS. 9A, 9B, 9C and 9D are views illustrating a waveform of a modulation signal in the present exemplary embodiment.

FIG. 10 is a view illustrating one example of a waveform of a modulation pulse.

FIG. 11 is a view illustrating one example of a waveform of a modulation pulse.

FIG. 12 is a block diagram illustrating an arrangement of an image display apparatus.

FIG. 13 is a block diagram illustrating a circuit configuration of a modulation circuit.

FIG. 14 is a block diagram illustrating an arrangement of a logic circuit in a modulation circuit.

FIG. 15 is a block diagram illustrating an arrangement of an output circuit in a modulation circuit.

FIG. 16 is a block diagram illustrating an arrangement of a reference wave generation circuit.

FIG. 17 is an arrangement example of a circuit for generating a rising slope edge.

FIG. 18 is an arrangement example of a circuit for generating a falling slope edge.

FIG. 19 is a timing chart illustrating an operation example 1 of an output circuit.

FIG. 20 is a logic table of an operation example 1.

FIG. 21 is a timing chart illustrating an operation example 2 of an output circuit.

FIG. 22 is a logic table of an operation example 2.

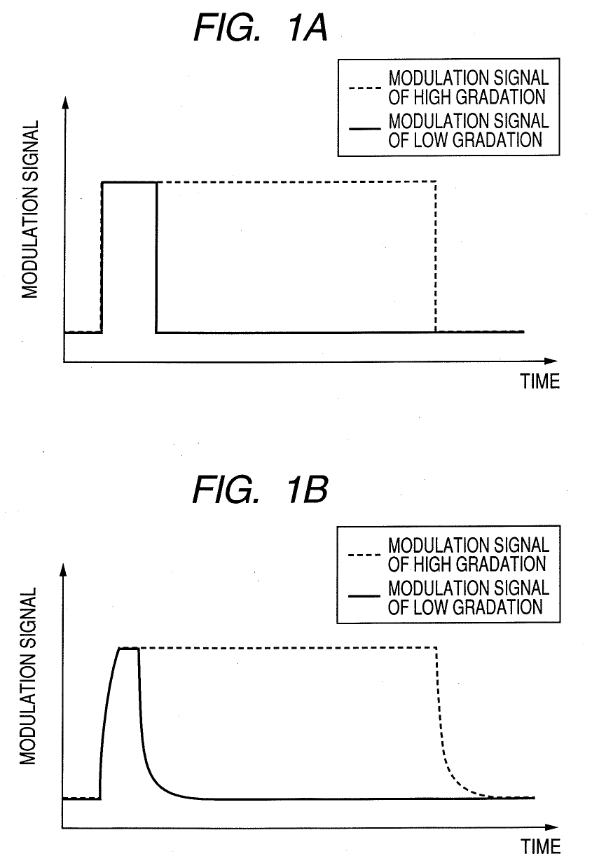

### DESCRIPTION OF THE EMBODIMENTS

### First Embodiment

Embodiments according to the present invention will now be described below, by referring to an image display apparatus using an electron-emitting device as a display element as an example.

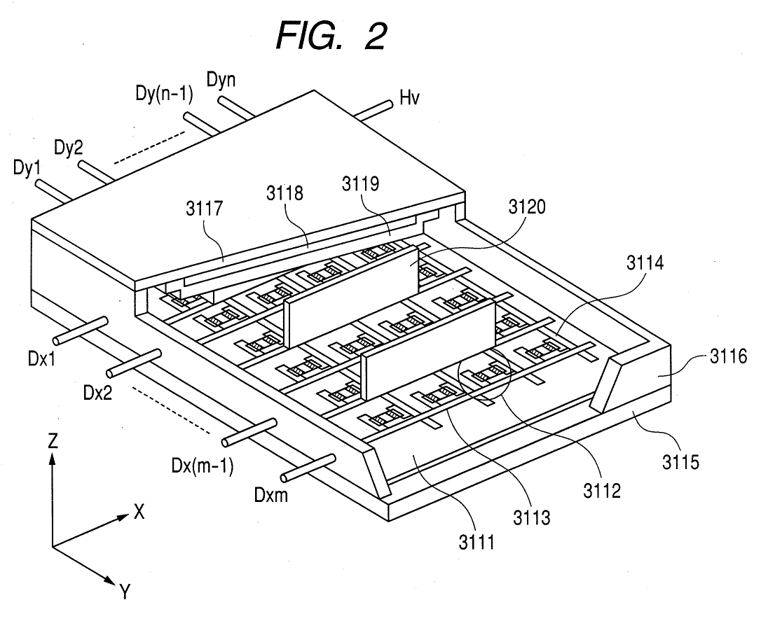

FIG. 2 is a perspective view illustrating one example of a display panel of an image display apparatus using an electron-emitting device, in which one part of the panel is cut away for illustrating an inner structure.

In the figure, a rear plate 3115, a side wall 3116 and a face plate 3117 are shown. The rear plate 3115, the side wall 3116 and the face plate 3117 forms an airtight container for keeping the inner part of a display apparatus vacuum.

A substrate 3111 is fixed on the rear plate 3115. N×M pieces of electron-emitting devices 3112 are formed on this substrate 3111 (N and M are positive integer numbers of 2 or more, and are appropriately set depending on an objective pixel number). In addition, the above described N×M pieces of the electron-emitting devices 3112 are wired with M lines of scan wires 3113 and N lines of modulation wires 3114. An insulating layer (not shown) is formed between scan wires 3113 and modulation wires 3114 at least at portions at which the scan wires 3113 intersect with the modulation wires 3114, and keeps the scan wires 3113 at an electrically insulated state from the modulation wires 3114.

A phosphor 3118 is formed on a lower face of the face plate 3117, in which phosphors (not shown) of three primary colors of red (R), green (G) and blue (B) are coated separately from each other. A black body (not shown) is provided in between the phosphors 3118. A metal back 3119 made from aluminum or the like is formed on the surface in a rear plate 3115 side of the phosphor 3118.

Dx1 to Dxm, Dy1 to Dyn and Hv are terminals for electrical connection having an airtight structure, which is provided for electrically connecting a display panel with a not-shown electric circuit. Dx1 to Dxm are electrically connected with the scan wire 3113, Dy1 to Dyn with the modulation wire 3114, and Hv with the metal back 3119, respectively.

The inner part of the above described airtight container is held at a vacuum of approximately 10⁻⁴ Pa. Therefore, as the display area of the image display apparatus becomes larger, some measure becomes necessary for preventing the rear plate 3115 and the face plate 3117 from being deformed or destroyed by a difference between atmospheric pressures in the inner part and the outer part of the airtight container. Then, a spacer 3120 is provided that is made from a comparative thin glass plate and supports atmospheric pressure. In this way, a gap between the rear plate 3115 and the face plate 3116 is normally kept at sub-millimeter to several millimeters, and the inner part of the airtight container is kept at a high vacuum.

The image display apparatus using the above described display panel emits electrons from each of the electron-emitting devices 3112, when voltage is applied to each of the electron-emitting devices 3112 through external terminals Dx1 to Dxm and Dy1 to Dyn of the container. At the same time, the image display apparatus applies several hundreds [V] to several [kV] of high voltage to the metal back 3119 through the external terminal Hv of the container, causes the above described emitted electrons to be accelerated, and causes the electrons to collide against the inner face of the face plate 3117. Thereby, the phosphors 3118 are excited to emit light and an image is displayed.

In the present embodiment, a surface-conduction type electron-emitting device was employed as the electron-emitting device 3112.

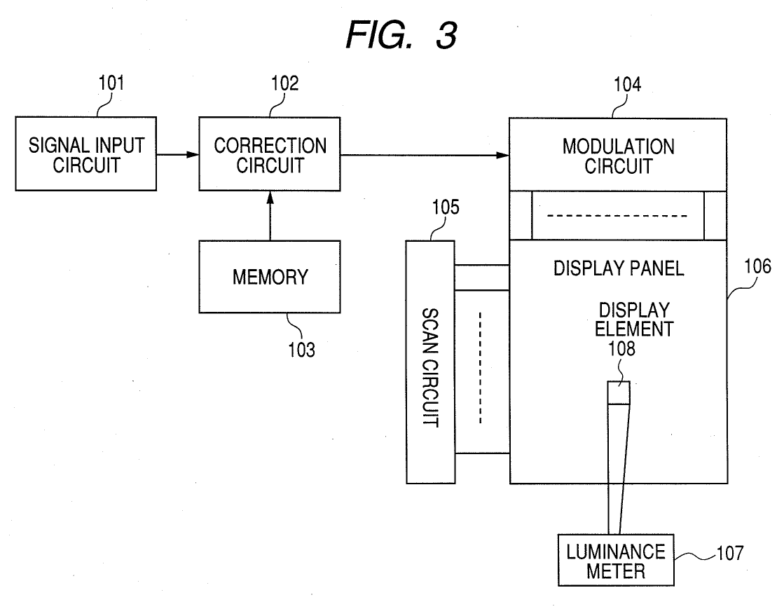

FIG. 3 is a view illustrating a drive circuit for driving a display panel according to the present invention. It illustrates a signal input circuit 101 on which an image data is input, a memory 103 that memorizes a correction value to be used for correcting a display element 108, and a correction circuit 102 that corrects an image data by using the correction value which has been held in the memory 103. It also illustrates a modulation circuit 104 that outputs a modulation signal, a scan circuit 105 that outputs a scan signal, and a display element 108 that is a unit of a display image (sub-pixel). It also illustrates a luminance meter 107 that measures the luminance of the display element 108.

As an example of a correction method, there is a method of storing a correction value which has been determined by measuring the luminance of each display element 108 in the memory 103, with the use of the luminance meter 107 such as CCD, and inputting a data of a corrected image data to the modulation circuit 104 when an image is displayed. Current/voltage characteristics of the electron-emitting device (luminance characteristics) are generally non-linear, so that the correction value can be determined not for one particular gradation but for a plurality of gradations.

By the way, a unit for measuring the luminance of the display element 108 is not necessarily limited to a luminance meter. In the case of the electron-emitting device, for instance, there is a correlation between the luminance and a current to be emitted from the electron-emitting device, so that the luminance may be measured with an ammeter for measuring the current.

The modulation circuit 104 was employed which has an enhanced resolution of the gradation by forming a waveform of voltage to be output from the modulation circuit 104 into a waveform in which pulse-width modulation (PWM) and pulse-amplitude modulation (PHM) are combined.

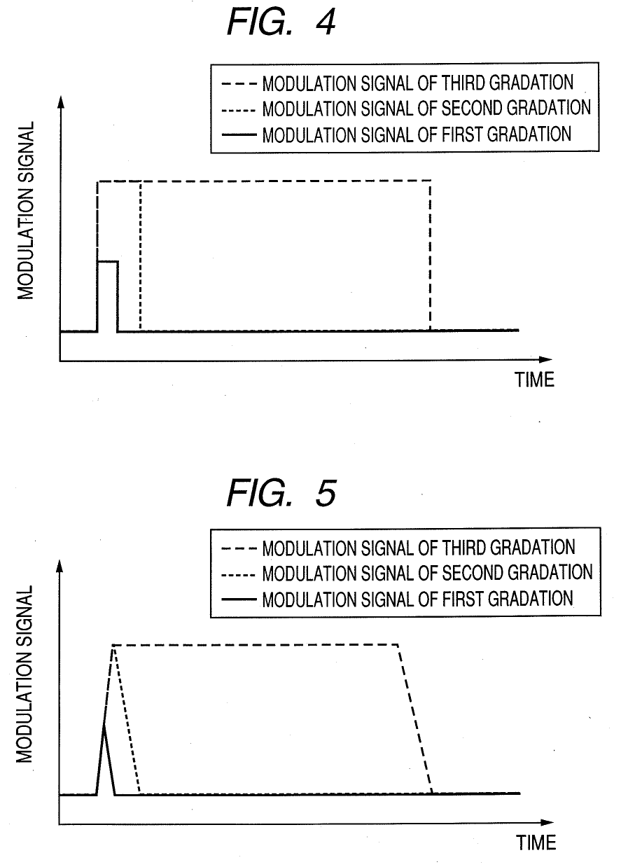

The modulation circuit 104 outputs particularly such waveforms in low gradations that the modulation signals are similar shapes to each other, and outputs such waveforms in high gradations that the modulation signals are not similar shapes to the modulation signals in the low gradations. In the present embodiment, a modulation circuit 104 was employed which output such waveforms in the low gradations that the modulation signals were similar rectangles to each other, and output such waveforms in the high gradations that the modulation signals were nonsimilar rectangles to the modulation signals in the low gradations, as is illustrated in FIG. 4.

More specifically, a waveform in a smaller gradation (first gradation, for instance) than the second gradation is a rectangular waveform which is similar to that of the second gradation. On the other hand, a waveform in a larger gradation (third gradation, for instance) than the second gradation is a rectangular waveform which is not similar to those of the first gradation and the second gradation.

In the present embodiment, the memory 103 stores a correction value derived by measuring the luminance of at least the second gradation with respect to each of the display elements 108. The correction circuit 102 corrects a signal for a smaller gradation (first gradation, for instance) than the second gradation by using a correction value which has been determined by measuring the luminance of the second gradation stored in the memory 103.

According to the present embodiment, when a distortion of a waveform occurs, the distortions of waveforms are also approximately similar, so that amounts of the influence due to the distortion of the waveform (rate of distortion in a waveform out of a waveform of modulation signal including distortion of the waveform) are almost the same. Accordingly, the image display apparatus can enhance the accuracy of the correction compared to the case of correcting a modulation signal by using a correction value that has been derived by measuring the luminance in the gradation of which the modulation signal has not a similar waveform to that of the signal to be corrected.

In the present embodiment, a structure was described in which a signal for the first gradation is corrected by using a correction value that has been derived by measuring the luminance of the second gradation that is larger than the first gradation, but the present invention is not limited to such a structure. Specifically, a signal for the second gradation may be corrected by using the correction value which has been calculated by measuring the luminance of the first gradation. In this case as well, the modulation signal in the first gradation is a similar shape to the modulation signal in the second gradation, and accordingly can enhance the accuracy of the correction compared to the case of correcting a signal by using the correction value which has been determined by measuring the luminance in the gradation of which the modulation signal has not a similar waveform to that of the signal to be corrected.

However, it takes a long time to measure the luminance in a low gradation side with high accuracy. Therefore, it is possible to determine a correction value by measuring the luminance of the second gradation that is the larger one out of the modulation signal in the first gradation and the modulation signal in the second gradation that are similar modulation signals, and to correct a signal in the first gradation that is the smaller gradation by using the correction value. Furthermore, the second gradation can be the largest gradation among gradations of which the modulation signals are similar shapes.

Incidentally, in the present embodiment, the modulation signal in the third gradation uses a rectangular waveform that is not similar to those in the first gradation and the second gradation, but the present embodiment does not eliminate an arrangement in which modulation signals in all gradations are similar shapes. When the modulation signals in all gradations are similar shapes, the third gradation becomes unnecessary that has been described above for illustrating the present embodiment, and the present embodiment can be described only by the above described first gradation and second gradation.

However, in order to display an image with a higher luminance, the waveform to be determined by the pulse width and the pulse amplitude of the modulation signal can have a larger area. Therefore, an arrangement in which the modulation signals in the low gradation side are similar shapes and the modulation signals in the high gradation side are not similar shapes to those in the low gradation side can be rather employed than an arrangement in which the modulation signals in all gradations are similar shapes.

### Second Embodiment

In the present embodiment, a modulation circuit 104 is employed which output such waveforms in low gradations that the modulation signals were similar triangles to each other, and output such waveforms in high gradations that the modulation signals were not similar to the modulation signals in the low gradations, as is illustrated in FIG. 5.

More specifically, a waveform in a smaller gradation (first gradation, for instance) than the second gradation is a triangular waveform which is similar to that of the second gradation. On the other hand, a waveform for a larger gradation (third gradation, for instance) than the second gradation is a trapezoidal waveform. Other structures are similar to those in the first embodiment.

In the present embodiment as well, the accuracy of the correction can be enhanced compared to the case of correcting a signal by using a correction value that has been derived by measuring the luminance in the gradation of which the modulation signal has not a similar waveform to that of the signal to be corrected.

Furthermore, a triangular modulation signal rises more slowly than a rectangular modulation signal, and accordingly can inhibit ringing.

Incidentally, in the present embodiment, the modulation signal in the third gradation uses a trapezoidal waveform, but the present embodiment does not eliminate an arrangement in which modulation signals in all gradations are similar triangles. When the modulation signals in all gradations are similar triangles, the third gradation becomes unnecessary that has been described above for illustrating the present embodiment, and the present embodiment can be described only by the above described first gradation and second gradation.

However, in order to display an image with a higher luminance, the waveform to be determined by the pulse width and the pulse amplitude of the modulation signal can have a larger area. Therefore, an arrangement in which the modulation signals in the low gradation side are similar triangles and the modulation signals in the high gradation side are not similar to those in the low gradation side (trapezoid, for instance) can be rather employed than an arrangement in which the modulation signals in all gradations are similar triangles.

### Third Embodiment

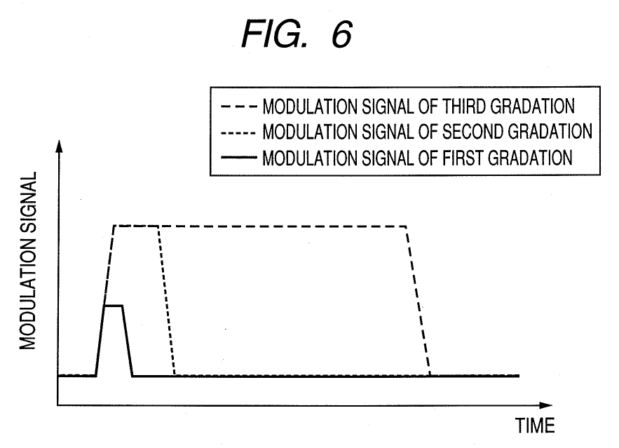

In the present embodiment, a modulation circuit 104 is employed that outputs such waveforms in low gradations that the modulation signals were similar trapezoids to each other, and output such trapezoids in high gradations that the modulation signals were not similar to the modulation signals in the low gradations, as is illustrated in FIG. 6.

More specifically, a waveform for a smaller gradation (first gradation, for instance) than the second gradation is a trapezoidal waveform that is similar to that of the second gradation. On the other hand, a waveform in a larger gradation (third gradation, for instance) than the second gradation is a trapezoidal waveform that is not similar to those of the first gradation and the second gradation. Other structures are similar to those in the first embodiment.

In the present embodiment as well, the accuracy of the correction can be enhanced compared to the case of correcting a signal by using a correction value that has been derived by measuring the luminance in the gradation of which the modulation signal has not a similar waveform to that of the signal to be corrected.

Furthermore, a trapezoidal modulation signal in the present embodiment rises more slowly than a rectangular modulation signal, and accordingly can inhibit ringing. The inhibition of ringing can inhibit a display element from being destroyed and an image quality from being degraded.

In addition, the trapezoidal modulation signal has smaller portions of rising and falling, which occupy the waveform of the modulation signal, than a triangular modulation signal, and accordingly can be less affected by the distortion of the waveform.

Incidentally, in the present embodiment, the modulation signal in third gradation uses a trapezoidal waveform that is not similar to those in the first gradation and the second gradation, but the present embodiment does not eliminate an arrangement in which modulation signals in all gradations are similar shapes. When the modulation signals in all gradations are similar shapes, the third gradation becomes unnecessary that has been described above for illustrating the present embodiment, and the present embodiment can be described only by the above described first gradation and second gradation.

However, in order to display an image with a higher luminance, the waveform to be determined by the pulse width and the pulse amplitude of the modulation signal can have a larger area. Therefore, an arrangement in which the modulation signals in the low gradation side are similar and the modulation signals in the high gradation side are not similar to those in the low gradation side can be rather employed than an arrangement in which the modulation signals in all gradations are similar shapes.

### Fourth Embodiment

In the above described embodiment, the present invention has been described by referring to an image display apparatus with the use of a surface-conduction type electron-emitting device, as an example, but the present invention can also be applied to an image display apparatus with the use of other electron-emitting devices than the surface-conduction type electron-emitting device.

In addition, the present invention can also be applied to an image display apparatus with the use of other display elements than the electron-emitting device.

For instance, the present invention can be applied to an image display apparatus with the use of an organic electroluminescence device, a plasma display apparatus, a liquid crystal display apparatus and the like.

The present invention can be preferably applied to an image display apparatus particularly with the use of a passive matrix drive as a driving method of the image display apparatus. In the image display apparatus employing the passive matrix drive, voltage is applied to a large number of modulation wires while one scan wire being selected, so that an electric current which passes through the scan wire is extremely larger than an electric current which passes through the modulation wire. If the scan wire had large resistance at this time, the current which passes through the scan wire results in causing a voltage drop, which makes it difficult to apply an appropriate voltage to a display element. For this reason, generally, the impedance of the scan wire is set to be smaller than that of the modulation wire.

The distortion of the waveform of the scan signal can occur, but the impedance of the scan wire is extremely smaller than that of the modulation wire, so that the distortion of the waveform of the scan signal is also small. Therefore, it is possible to correct variations of luminance characteristics of a display element with high accuracy by applying the present invention to a modulation signal having a large impedance which exerts a great effect on the distortion of the waveform.

### Exemplary Embodiments

### Exemplary Embodiment 1

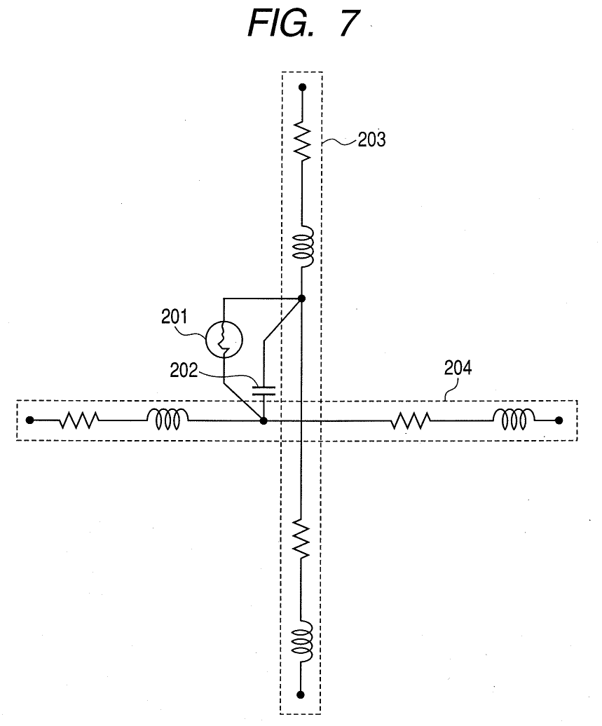

An equivalent circuit of an image display apparatus having an electron-emitting device as illustrated in FIG. 2 was assembled, and a simulation was conducted with the use of a circuit simulator. FIG. 7 is a view illustrating the equivalent circuit of a display element according to the present invention.

The behavior of the electron emission of an electron-emitting device 201 caused by an electric field was expressed by the expression of Fowler Nordheim. The resistance of one line of a scan wire 204 was set at 5 Ω, the resistance of one line of a modulation wire 203 was set at 400 Ω, and variations of luminance when the resistance of the modulation wire varied in a range of ±50 Ω were determined by calculation. A capacitance 202 was set at 0.4 pF, which was a total of a capacity at an intersection between each display element and a parasitic capacity of the element.

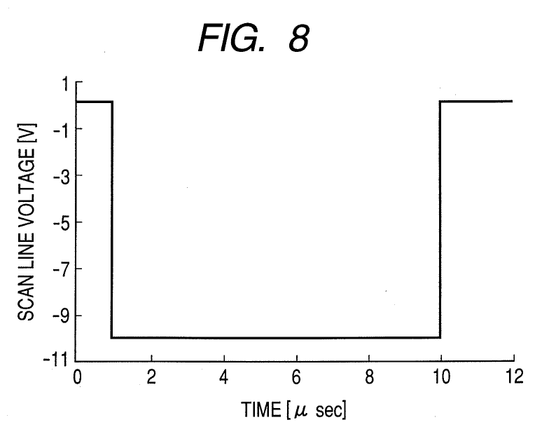

In the present exemplary embodiment, a pulse voltage of −10 V was applied to one scan wire 204 from a scan circuit 105 in a period in which the wire is selected, as is illustrated in FIG. 8.

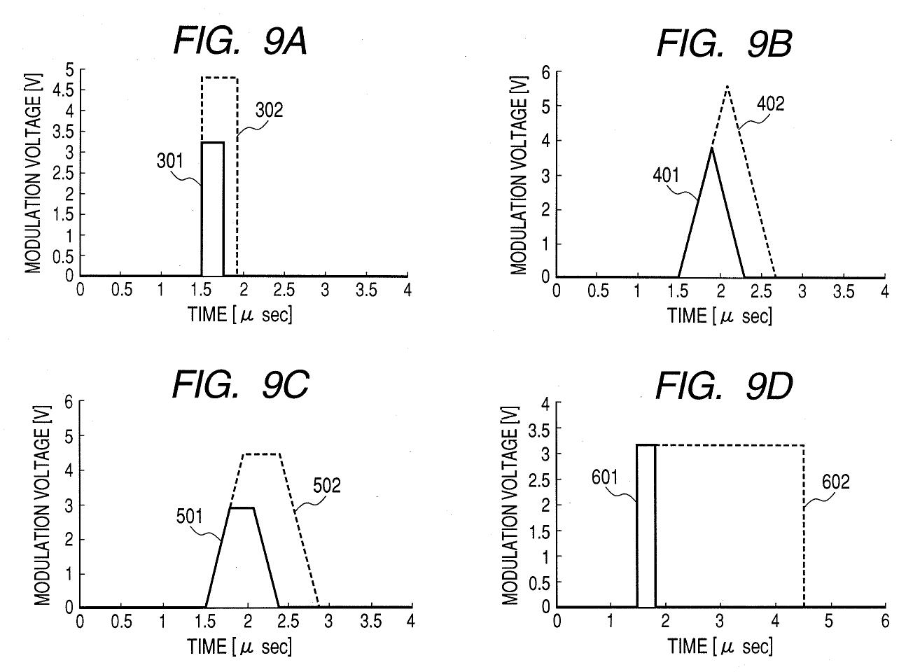

In the present exemplary embodiment, a rectangular modulation signal as illustrated in FIG. 9A was output from a modulation circuit 104. In the figure, a modulation signal 301 shows a signal of the first gradation, and a modulation signal 302 shows a signal of the second gradation. A signal of the first gradation was corrected with the use of a correction value derived from the luminance obtained when the modulation signal 302 in the second gradation was applied to a display element.

More specifically, in the present exemplary embodiment, the number of total gradations was set at 256, modulation signals from gradation 0 to gradation 80 were set so as to be similar rectangles to each other, and modulation signals from gradation 81 to gradation 255 were set so as to be rectangles that are not similar to the modulation signals from gradation 0 to gradation 80. In the present exemplary embodiment, the first gradation was determined to be gradation 40, and the second gradation was determined to be gradation 80.

In the present exemplary embodiment, simulation was performed under the following conditions, while three display elements of A, B and C were used.

At first, resistances of modulation wires to be connected to the display elements of A, B and C were set at 350 Ω, 400 Ω and 450 Ω respectively. In this case, the distortion in the waveform of the modulation signal of the display element C is the largest, and the luminance of the display element C is the smallest.

Here, the luminance of each display element in the gradation 80 corresponding to the second gradation according to the present invention was measured, and the results were set at L_{MA}, L_{MB} and L_{MC} respectively. When luminances are corrected based on the display element C, the correction value M_{A} of the display element A is L_{MC}/L_{MA}, the correction value M_{B} of the display element B is L_{MC}/L_{MB}, and the correction value M_{C} of the display element C is L_{MC}/L_{MC}. These correction values are stored in a memory 103.

In the present exemplary embodiment, only the influence of the impedance of wires is considered, but practically, the correction values may be stored while considering an error in a luminance measurement, a quantization error which occurs when the correction value is stored in the memory 103 and the like.

Table 1 shows the luminance of each display element and the variations among the luminances in the first gradation (gradation 40), the luminance of each display element in the second gradation (gradation 80), and the correction value determined from the luminance of each display element in the second gradation.

Table 1 also shows the gradation after correction that was obtained by multiplying the first gradation by the correction value determined from the luminance of the second gradation, and the luminance of each display element in the gradation after correction and the variations among the luminances.

TABLE 1

| | Lumi- | Lumi- | | | Lumi- |
|---|---|---|---|---|---|
| Resistance | nance | nance | | | nance |
| [Ω] of | [cd/m²] of | [cd/m²] of | | Gradation | [cd/m²] |
| modulation | gradation | gradation | Correction | after | after |
| wire | 40 | 80 | value | correction | correction |
| 350 | 1.20 | 14.89 | 0.866 | 35 | 1.03 |
| 400 | 1.13 | 13.85 | 0.931 | 37 | 1.05 |
| 450 | 1.07 | 12.89 | 1.000 | 40 | 1.07 |
| Variations | 11.54 | | | | 2.92 |
| [%] | | | | | |

In the present exemplary embodiment, the variations of the luminance in the first gradation that were 11.54% before the correction could be reduced to 2.92% by the correction.

In the present exemplary embodiment, the gradation after correction was determined by multiplying the first gradation (gradation 40) by the correction value, on condition that the number of the gradation and the luminance have a linear relationship. However, when the number of the gradation and the luminance have a non-linear relationship, the gradation after the correction can be determined while considering these conditions.

### Exemplary Embodiment 2

In the present exemplary embodiment as well, the same simulation as that in Exemplary embodiment 1 was performed. The present exemplary embodiment is different from Exemplary embodiment 1 in a point that a modulation circuit 104 output a modulation signal of a triangle as illustrated in FIG. 9B. In the figure, a modulation signal 401 shows a signal of the first gradation, and a modulation signal 402 shows a signal of the second gradation. A signal for the first gradation was corrected by using a correction value derived from the luminance obtained when the modulation signal 402 in the second gradation was applied to a display element.

The result of the simulation in the present exemplary embodiment is shown in Table 2.

TABLE 2

| | Lumi- | Lumi- | | | Lumi- |
|---|---|---|---|---|---|
| Resistance | nance | nance | | | nance |
| [Ω] of | [cd/m²] of | [cd/m²] of | | Gradation | [cd/m²] |
| modulation | gradation | gradation | Correction | after | after |
| wire | 40 | 80 | value | correction | correction |
| 350 | 1.78 | 21.51 | 0.909 | 36 | 1.62 |
| 400 | 1.71 | 20.51 | 0.953 | 38 | 1.63 |
| 450 | 1.63 | 19.56 | 1.000 | 40 | 1.63 |
| Variations | 8.68 | | | | 0.87 |
| [%] | | | | | |

In the present exemplary embodiment, the luminance variations in the first gradation that were 8.68% before the correction could be reduced to 0.87% by the correction. In addition, ringing also did not almost occur.

### Exemplary Embodiment 3

In the present exemplary embodiment as well, a similar simulation to that in Exemplary embodiment 1 was performed. The present exemplary embodiment is different from Exemplary embodiment 1 in a point that a modulation circuit 104 outputs a modulation signal of a trapezoid as illustrated in FIG. 9C. In the figure, a modulation signal 501 shows a signal of the first gradation, and a modulation signal 502 shows a signal of a second gradation. A signal in the first gradation was corrected with the use of a correction value derived from the luminance obtained when the modulation signal 502 in the second gradation was applied to a display element.

The result of the simulation in the present exemplary embodiment is shown in Table 3.

TABLE 3

| | Lumi- | Lumi- | | | Lumi- |
|---|---|---|---|---|---|
| Resistance | nance | nance | | | nance |
| [Ω] of | [cd/m²] of | [cd/m²] of | | Gradation | [cd/m²] |
| modulation | gradation | gradation | Correction | after | after |
| wire | 40 | 80 | value | correction | correction |
| 350 | 3.22 | 38.99 | 0.981 | 39 | 3.16 |
| 400 | 3.18 | 38.62 | 0.990 | 39 | 3.15 |
| 450 | 3.13 | 38.24 | 1.000 | 40 | 3.13 |
| Variations | 2.70 | | | | 0.76 |
| [%] | | | | | |

In the present exemplary embodiment, the luminance variations in the first gradation that were 2.70% before the correction could be reduced to 0.76% by the correction. In addition, ringing also did not almost occur.

### COMPARATIVE EXAMPLE

In the present comparative example as well, a similar simulation to that in Exemplary embodiment 1 was performed. The present comparative embodiment is different from Exemplary embodiment 1 in that a modulation circuit 104 outputs a pulse-width-modulated modulation signal as illustrated in FIG. 9D. In the figure, a modulation signal 601 shows a signal of the first gradation, and a modulation signal 602 shows a signal of a second gradation. A signal in the first gradation was corrected with the use of a correction value derived from the luminance obtained when the modulation signal 602 in the second gradation was applied to a display element.

More specifically, in the present comparative example, the number of the gradations was set at 256, and modulation signals from gradation 0 to gradation 255 were set at rectangles that were not similar to each other. In the present comparative example, the first gradation was determined to be gradation 40, and the second gradation was determined to be gradation 80.

The result of the simulation in the present comparative example is shown in Table 4.

TABLE 4

| | Lumi- | Lumi- | | | Lumi- |
|---|---|---|---|---|---|
| Resistance | nance | nance- | | | nance |
| [Ω] of | [cd/m²] of | [cd/m²] of | | Gradation | [cd/m²] |
| modulation | gradation | gradation | Correction | after | after |
| wire | 40 | 80 | value | correction | correction |
| 350 | 1.20 | 35.05 | 0.987 | 39 | 1.18 |
| 400 | 1.13 | 34.82 | 0.994 | 39 | 1.12 |
| 450 | 1.07 | 34.60 | 1.000 | 40 | 1.07 |
| Variations | 11.54 | | | | 10.26 |
| [%] | | | | | |

In the present comparative example, the luminance variations in the first gradation that were 11.54% before the correction could only be reduced to 10.26% by the correction.

### Exemplary Embodiment 4

A specific circuit arrangement will now be described below that outputs a triangular or trapezoidal modulation signal shown in the above described exemplary embodiments.

An image display apparatus has a scan circuit and a modulation circuit as a drive unit for driving a display panel. The scan circuit is a circuit for outputting a selecting potential to one scan wire or a plurality of scan wires which are objects to be driven, and the modulation circuit is a circuit for generating a modulation pulse based on an image data and outputting the modulation pulse to a modulation wire. The modulation circuit according to the present embodiment generates a waveform of a modulation pulse (source waveform) by appropriately combining the first waveform which rises in a slope form, the second waveform which specifies a peak, and the third waveform which falls in a slope form. The modulation circuit has a logic circuit which generates a control signal for controlling a waveform based on the image data. The modulation circuit can adaptively control a timing of switching among the first waveform, the second waveform and the third waveform, the peak of the second waveform and the like, through the control signal.

Examples of a modulation pulse will now be described below which can be output by a modulation circuit in the present embodiment. Any of modulation pulses rises and falls in a slow slope form, so that the overshoot and undershoot, and the turbulence of the waveform such as ringing at the voltage transient can be reduced as much as possible. Accordingly, the modulation pulse can enhance the gradation properties of the image display apparatus.

### Example 1 of Modulation Pulse

A triangular pulse can be generated by outputting the third waveform following the first waveform. A larger pulse, in other words, a pulse corresponding to a larger gradation value can be generated by delaying a timing of switching the waveform from the first waveform to the third waveform.

### Example 2 of Modulation Pulse

A trapezoidal pulse can be generated by raising a pulse to a peak (h) in the first waveform, keeping the peak (h) in the second waveform, and lowering the pulse from the peak (h) in the third waveform. Here, a pulse corresponding to a large gradation value can be generated by extending a period of time of outputting the second waveform.

### Example 3 of Modulation Pulse

The triangular and trapezoidal pulses can be separately used according to a gradation value. For instance, the shape of the pulse is controlled according to the following method (1) when the gradation value is n (where n is an integer of 1 or more), and is controlled according to the following method (2) when the gradation value is in between n+1 and n+k (where k is an integer of 1 or more).

(1) When Outputting Modulation Pulse Corresponding to Gradation Value n

The control method is to raise the peak of the modulation pulse to h1 in a form of a slope by taking a period of time t1 from the starting time of the output of the modulation pulse, and lower the peak from the time point when the period of time t1 has passed after the output of the modulation pulse has started.

(2) When Outputting Modulation Pulse Corresponding to Gradation Value n+k

The control method is to raise the peak of the modulation pulse to h2 in a form of a slope by taking a period of time t2 from the starting time of the output of the modulation pulse, keep the peak h2 to the time point at which a period of time t2+f(k) has passed from the starting time of the output of the modulation pulse, and lower the peak.

Here, t2 is larger than t1, and h2 is larger than h1. In addition, f(k) is a value that increases as k increases. The f(k) is typically a linear function of k, but is not limited to the linear function as long as the function is a function that monotonically increases.

The control method in the above described (2) is a control method of increasing a pulse width (length in flat portion of trapezoidal waveform) according to a gradation value. Incidentally, if f(k) is 0 when k=1, the pulse in (2) becomes a triangular pulse. The triangular pulse which is obtained in the above described (1) corresponds to a pulse which is one gradation smaller than a pulse obtained when k=1 in the above described (2). Such a control method can realizes a smaller luminance than a luminance which can be expressed by a pulse-width modulation using a trapezoidal pulse (in other words, luminance when k=1), and can enhance the gradation properties of the image display apparatus.

In addition, the control method in the following (3) can also be performed.

(3) When Outputting Modulation Pulse Corresponding to Gradation value n−1

The control method is to raise the peak of the modulation pulse to h3 in a form of a slope by taking a period of time t3 from the starting time of the output of the modulation pulse, and lower the peak from the time point when the period of time t3 has passed after the output of the modulation pulse has started. Here, t3 is smaller than t1, and h3 is smaller than h1.

The control method in (3) generates a smaller triangular pulse than the pulse in the control method (1). Thereby, the control method in (3) can realize a smaller luminance than that in the control method (1), and can further enhance the gradation properties of the image display apparatus. A smaller triangular pulse than the pulse in the control method (3) may be generated in a similar way.

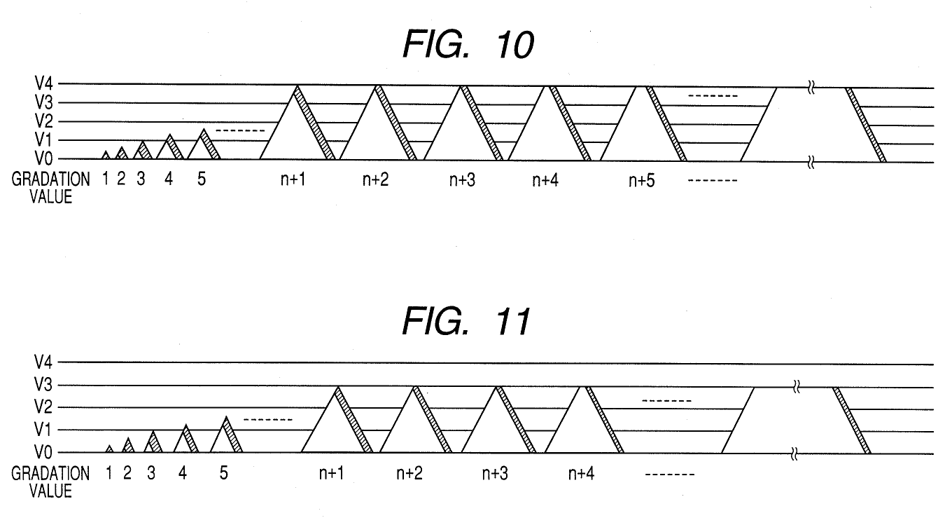

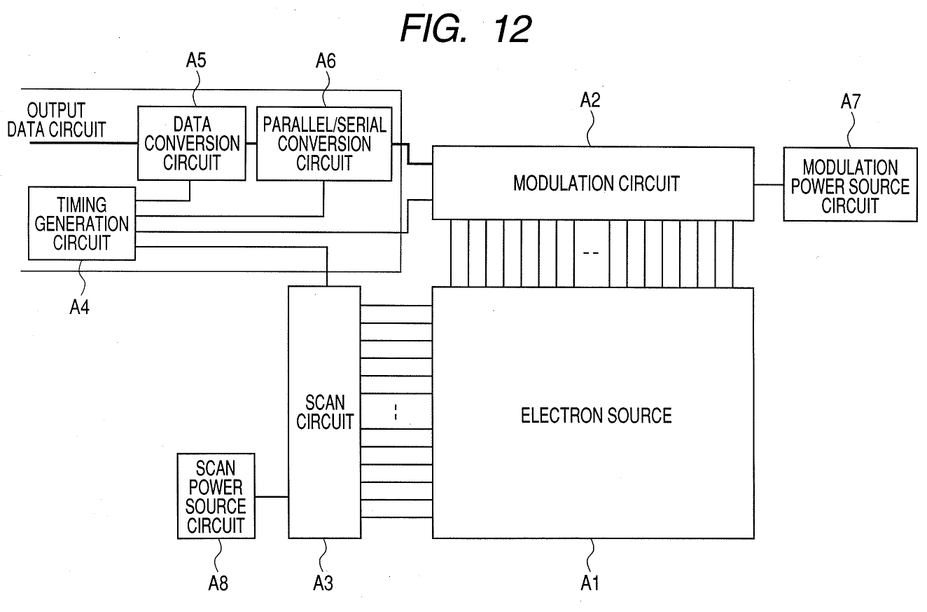

FIG. 10 and FIG. 11 illustrate one example of a waveform of a modulation pulse. In this example, a triangular pulse is gradually enlarged from gradation value 1 to n, and the pulse width of a trapezoidal pulse is gradually elongated for gradation value n+1 or later. In addition, a black part in the pulse waveform shows a difference between itself and a pulse one gradation before. In FIG. 10, the peak of a modulation pulse is in a level V4. In FIG. 11, the peak of the modulation pulse is in a level V3 (V4 is larger than V3). The modulation pulse in FIG. 10 can display a higher luminance than that in FIG. 11. For instance, when an image for which high luminance is preferred is displayed or when a display mode of high luminance is selected, the control method in FIG. 10 may be employed. On the other hand, when an image for which low luminance is preferred is displayed or when a display mode of low luminance is selected, the control method in FIG. 11 may be employed. When the peak is set at V1 or V2, further low luminance can be realized.

Then, an arrangement and control method of an image display apparatus for outputting the above described modulation pulse will now be specifically described below.

(Image Display Apparatus)

FIG. 12 is a block diagram illustrating an arrangement of an image display apparatus according to an exemplary embodiment of the present invention. The image display apparatus includes briefly an electron source A1 as a display panel (image display unit), and a driving apparatus for driving the electron source A1.

The driving apparatus comprises by an output data circuit, a modulation circuit A2, a scan circuit A3, a modulation power source circuit A7 and a scan power source circuit A8. The output data circuit includes a timing generation circuit A4, a data conversion circuit A5 and a parallel/serial conversion circuit A6.

The electron source A1 includes a plurality of electron-emitting devices, a plurality of scan wires and a plurality of modulation wires, and has an electron-emitting device formed on each intersection of the scan wires and the modulation wires. When a selecting potential is supplied to the scan wires and a modulation pulse is supplied to the modulation wires, a driving voltage which is a potential difference between the selecting potential and the modulation pulse is applied to the electron-emitting device. It is possible for a desired element to emit a light of a desired luminance by appropriately controlling an application period of time and a voltage value of this driving voltage.

The modulation circuit A2 is connected to the modulation wires of the electron source A1. This modulation circuit A2 is a circuit that generates a modulation signal (modulation pulse) based on an image data supplied from an output data circuit, and outputs the modulation signal to each of the modulation wires in the electron source A1.

The modulation power source circuit A7 is a power source circuit which is formed so as to be able to output a plurality of voltage values. The modulation power source circuit A7 is a power source for a circuit operation of the modulation circuit A2 and also is a power source for specifying the voltage value of the modulation pulse to be output from the modulation circuit A2. The modulation power source circuit A7 is generally a voltage source circuit, but is not necessarily limited to the voltage source circuit.

The scan circuit A3 is connected to the scan wires in the electron source A1. The scan circuit A3 is a circuit for selecting one or several scan wires from among all scan wires, which are objects to be driven, and sequentially switching the scan wire to be selected. In general, a line-sequential scan is performed that sequentially selects rows one by one, but a scanning method is not limited to the line-sequential scan. The scan circuit A3 can also employ a jumping scan (interlace scan) or a method of selecting a plurality of rows or selecting a plane (multi-line scan). The scan circuit A3 supplies a selecting potential to scan wires of objects to be driven (selected line), and supplies a non-selecting potential to other scan wires (non-selected line).

The scan power source circuit A8 is a power source circuit that outputs a plurality of voltage values (selecting potential and non-selecting potential). The power source circuit is generally a voltage source circuit, but is not necessarily limited to the voltage source circuit.

The timing generation circuit A4 is a circuit for generating a timing signal as a control data that controls timing in respective circuits of the modulation circuit A2, the scan circuit A3, the data conversion circuit A5 and the parallel/serial conversion circuit A6.

The data conversion circuit A5 is a circuit for converting the input luminance-gradation data to an image data suitable for the modulation circuit A2 and the electron source Al. For instance, the data conversion circuit A5 can subject the luminance-gradation data to signal processing such as reverse γ conversion, luminance correction, color correction, resolution conversion and an adjustment of the maximum value (limiter).

The parallel/serial conversion circuit A6 is a circuit which converts a parallel data for an image data output from the data conversion circuit 5 into a serial data, and outputs the serial data to the modulation circuit A2.

(Modulation Circuit)

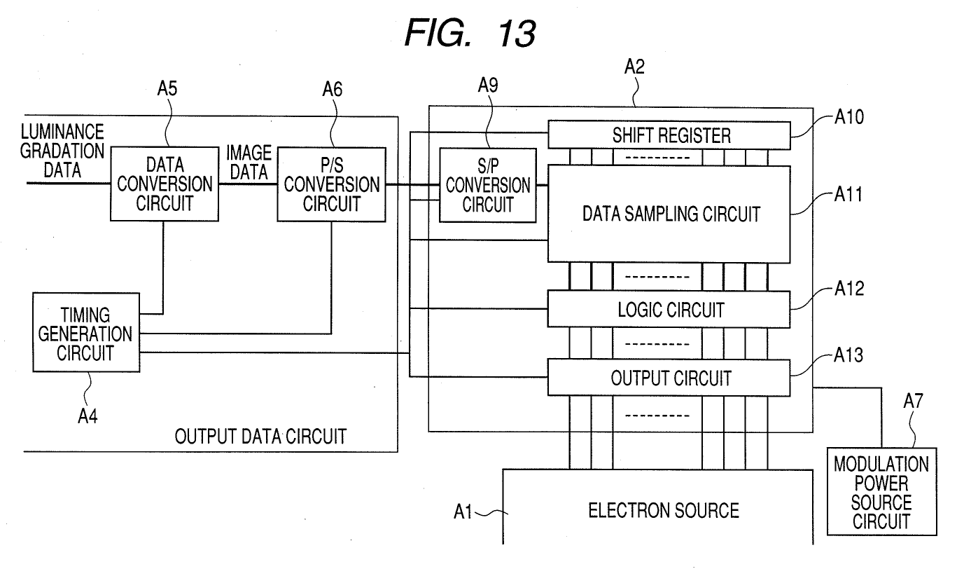

FIG. 13 is a block diagram illustrating a circuit arrangement of a modulation circuit A2. The modulation circuit A2 comprises a serial/parallel conversion circuit A9, a shift register A10, a data sampling circuit A11, a logic circuit A12 and an output circuit A13.

An operation of the modulation circuit A2 in the present exemplary embodiment will now be described.

An image data which has been output from an output data circuit is converted to a parallel data in the serial/parallel conversion circuit A9. The image data that has been converted to the parallel data is sequentially stored in the data sampling circuit All by the shift register A10.

An image data corresponding to a pixel number in a horizontal direction, (hereafter, referred to as M), of the electron source A1 is stored in the data sampling circuit A11. Afterward, the logic circuit A12 generates a control signal (control sequence) for the output circuit A13 based on the image data for each pixel, which has been stored in the data sampling circuit A11, and sends the control signal to the output circuit A13.

The output circuit A13 generates a modulation pulse based on the control signal (control sequence), and outputs the modulation pulse to the modulation wires of the electron source A1.

(Logic Circuit)

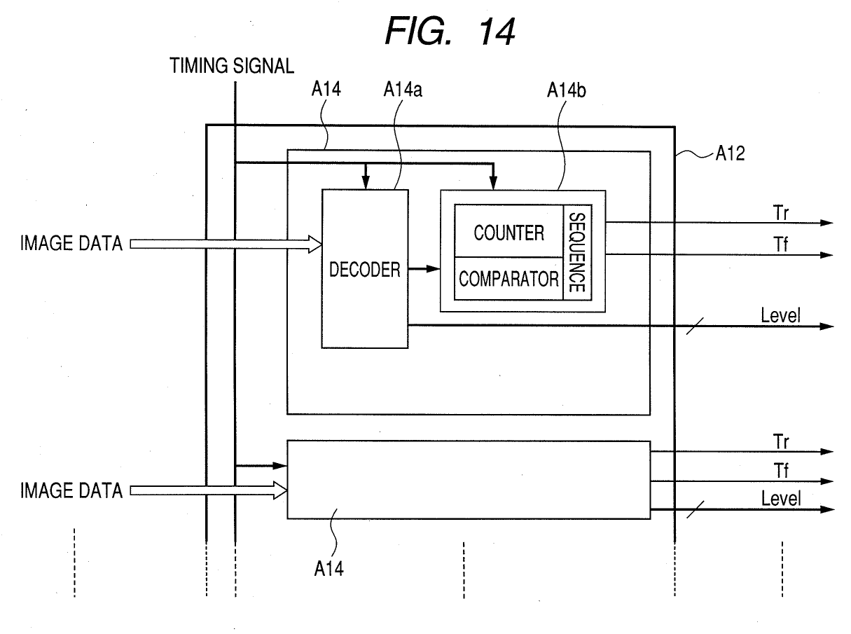

FIG. 14 is a block diagram illustrating an arrangement of the logic circuit A12 of the modulation circuit.

The logic circuit A12 includes M pieces of logic circuits A14. Each of the logic circuits A14 corresponds to each pixel. A specific arrangement and operation will now be described below, by referring to the logic circuit A14 for one pixel as an example.

The logic circuit A14 includes a decoder A14a and a sequence generation circuit A14b. The image data that has been sampled in a data sampling circuit A11 is input into the decoder A14a. The decoder A14a generates a data for controlling the rising timing and falling timing of the modulation pulse from the image data and a timing signal sent from the output data circuit. The control data is input into the sequence generation circuit A14b, and is used as a data for a comparator. The decoder A14a generates a control signal Level for specifying the output level of the modulation pulse from the image data and the timing signal. The control signal Level is input into the output circuit A13.

The sequence generation circuit A14b counts the number of the clock based on the clock signal to be supplied as the timing signal. A comparator in the sequence generation circuit A14b compares the count value with the data for controlling the rising timing and the falling timing. Then, the sequence generation circuit A14b generates a control signal Tr for specifying the rising timing of the modulation pulse and a control signal Tf for specifying the falling timing of the modulation pulse, based on the value of the comparator. The control signals Tr and Tf are input into the output circuit A13.

(Output Circuit)

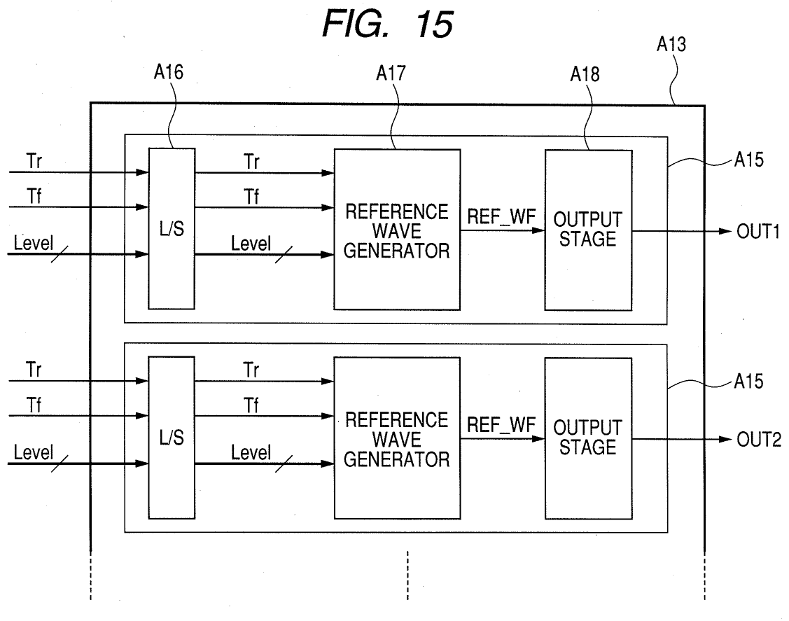

FIG. 15 is a block diagram illustrating an arrangement of the output circuit A13 of the modulation circuit.

The output circuit A13 includes M pieces of output circuits A15. Each of the output circuits A15 corresponds to each pixel (each modulation wire). A specific arrangement and operation will now be described below, by referring to the output circuit A15 for one pixel as an example.

The output circuit A15 comprises a level shift circuit A16, a reference wave generation circuit A17 and an output stage A18.

Control signals Tr, Tf and Level which have been sent from the logic circuit A14 are input into the output circuit A15. The level shift circuit A16 converts the voltage in a logic level of the control signals Tr, Tf and Level to the voltage in an operation level of the output circuit A15. The control signals Tr, Tf and Level which have been output from the level shift circuit A16 are input into the reference wave generation circuit A17.

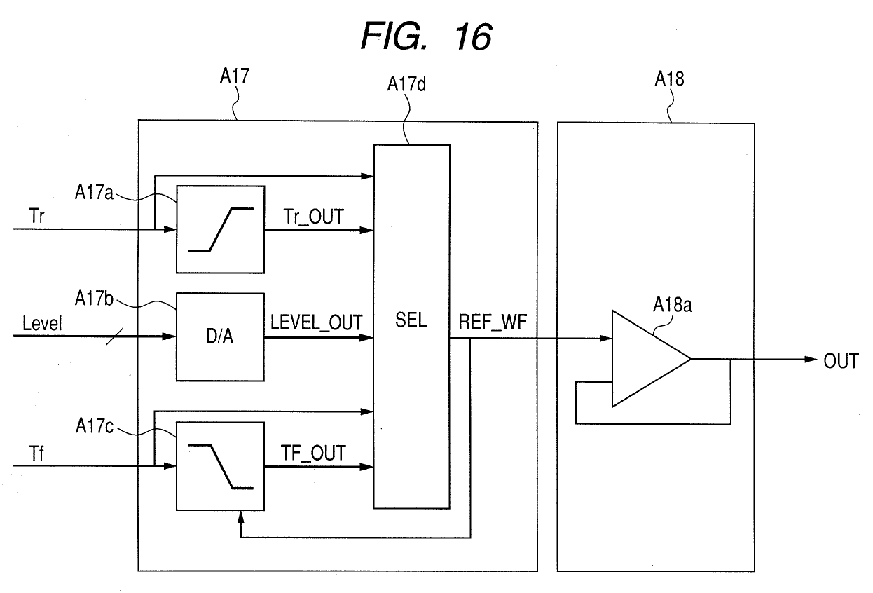

FIG. 16 is a block diagram illustrating an arrangement of a reference wave generation circuit A17. The reference wave generation circuit A17 comprises a rising reference waveform generation portion A17a, an output level generation portion A17b, a falling reference waveform generation portion A17c and a waveform switching portion A17d.

In the present embodiment, the rising reference waveform generation portion A17a, the output level generation portion A17b and the falling reference waveform generation portion A17c correspond to the first waveform generation portion, the second waveform generation portion and the third waveform generation portion according to the present invention, respectively. The waveform switching portion A17d corresponds to a waveform switching portion according to the present invention.

(Generation of Rising Waveform)

An operation of generating a rising waveform will now be described.

A level-shifted control signal Tr is input into a rising reference waveform generation portion A17a. When the control signal Tr is input, the rising reference waveform generation portion A17a generates a rising slope edge having a predetermined gradient and outputs the rising slope edge. The rising slope edge (first waveform) may employ any waveform as long as the waveform slowly rises with a slope shape. A waveform which monotonically increases can be employed, and further a waveform having a constant gradient can be employed. This is because the gradation can be easily controlled.

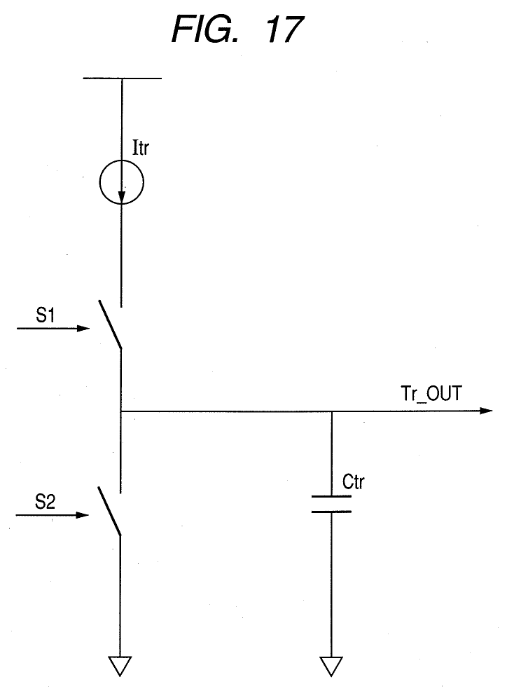

FIG. 17 is an arrangement example of a circuit for generating a rising slope edge. This circuit comprises switches S1 and S2, a current source Itr and a capacitor Ctr.

When the control signal Tr is in an On state (High), the switch S1 is in an On state, and the switch S2 is in an Off state. By the change to the On state of the switch S1, a fixed amount of an electric current flows into the capacitor Ctr from the current source Itr, and an electric charge is charged therein. This operation allows an output voltage Tr_OUT to be a waveform having a constant gradient.

When the control signal Tr changes to an Off state (Low), the switch S1 turns to the Off state, and the switch S2 turns to the On state. This operation causes the electric charge that has been charged in the capacitor Ctr to be discharged, and the output voltage Tr_OUT becomes 0V. In this example, such a current source as to direct the ground may be connected in a switch S2 side.

(Generation of Output Level)

An operation of generating an output level will now be described.

A level-shifted control signal Level is input into the output level generation portion A17b. The output level generation portion A17b subjects the control signal Level to a digital/analog conversion step, and outputs a voltage level signal LEVEL_OUT having a fixed voltage. This voltage level signal LEVEL_OUT is a waveform for specifying the peak of the modulation pulse (second waveform).

(Generation of Falling Waveform)

An operation of generating a falling waveform will now be described.

A level-shifted control signal Tf is input into a falling reference waveform generation portion A17c. The voltage of a reference waveform REF_WF to be output from a waveform switching portion A17d is always applied to the falling reference waveform generation portion A17c. The reason why the voltage of the reference waveform REF_WF is always applied to the falling reference waveform generation portion A17c is to generate a waveform which falls from the voltage level that is output from the waveform switching portion A17d. Specifically, when the control signal Tf is input, the falling reference waveform generation portion A17c generates a slope edge falling from the value of the voltage of the reference waveform REF_WF with a predetermined gradient, and outputs an output voltage Tf_OUT.

The falling slope edge (third waveform) may employ any waveform as long as the waveform slowly falls with a slope shape. A waveform which monotonically decreases can be employed, and further a waveform having a constant gradient can be employed. This is because the gradation can be easily controlled.

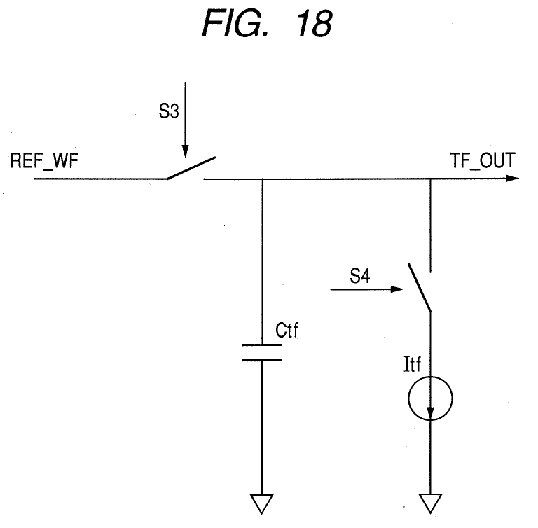

FIG. 18 is an arrangement example of a circuit for generating a falling slope edge. This circuit comprises switches S3 and S4, a current source Itf and a capacitor Ctf.

When the control signal Tf is in an On state (High), the switch S3 is in an On state, and the switch S4 is in an Off state. Thereby, the same voltage as the reference waveform REF_WF is input, and the capacitor Ctf is charged.

When the control signal Tf is in the Off state (Low), the switch S3 is in the Off state, and the switch S4 is in the On state. By this operation, the output voltage Tf_OUT is changed into a falling waveform having a fixed gradient from the voltage of the reference waveform REF_WF right before the falling starts, and eventually reaches a ground level.

(Generation of Output Waveform)

A waveform-switching operation and an output waveform operation will now be described.

A waveform switching portion A17d generates a reference waveform REF_WF by switching reference waveforms (output voltages) in a rising reference waveform generation portion A17a, an output level generation portion A17b and a falling reference waveform generation portion A17c, based on control signals Tr and Tf, and outputs the reference waveform REF_WF to an output stage A18.

Specifically, the waveform switching portion A17d selects an output voltage Tr_OUT of the rising reference waveform generation portion A17a when the control signal Tr is High, and selects an output voltage LEVEL_OUT of the output level generation portion A17b when the control signal Tr is Low.

In addition, the waveform switching portion A17d gives priority to the logic of the control signal Tr when the control signal Tf is High, and selects an output voltage Tr_OUT of the falling reference waveform generation portion A17c when the control signal Tf is Low.

The output stage A18 refers to the output waveform REF_WF from the waveform switching portion A17d and generates a modulation pulse having the same waveform or a similar waveform. The modulation pulse OUT is output to the modulation wires of a electron source A1. The output stage A18 can have a unity gain buffer arrangement with the use of an operational amplifier A18a as illustrated in FIG. 16. Alternatively, the output stage A18 may have an amplification stage arrangement of the operational amplifier.

### Operation Example 1

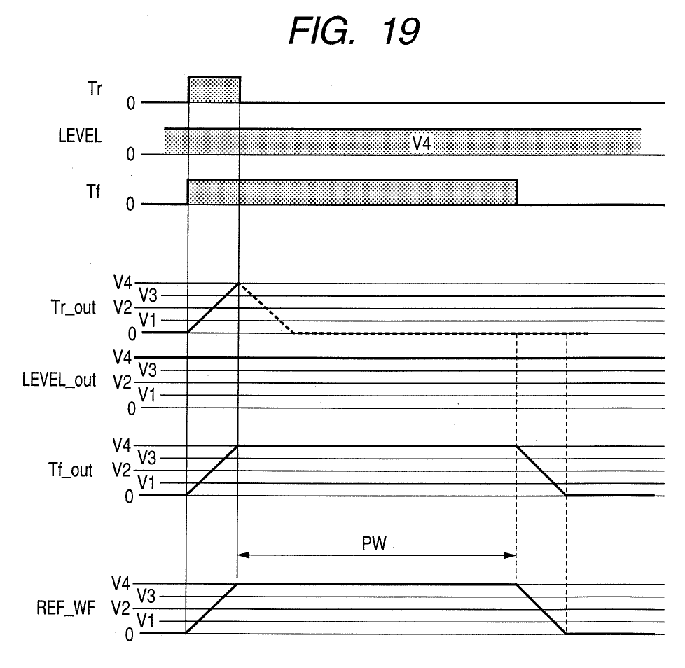

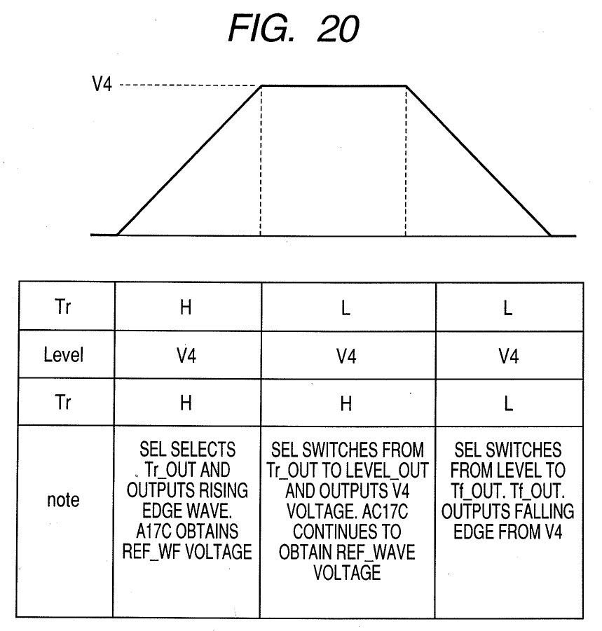

One example of an operation timing of an output circuit A15 will now be described with reference to FIG. 19 and FIG. 20. FIG. 19 is a timing chart illustrating Operation example 1 of the output circuit A15, and FIG. 20 is a logical table of Operation example 1. Operation example 1 is a control method to be employed when outputting a modulation pulse of the maximum voltage level (V4).

A control signal Level is input into an output level generation portion A17b, and a voltage level signal LEVEL_OUT is output. In this example, level V4 is output.

When the control signal Tr is in a level High, a rising waveform Tr_OUT having a fixed gradient is output from a rising reference waveform generation portion A17a. When the control signal Tr is in a level Low, the Tr_OUT becomes 0 V (ground level).

When a control signal Tf is in a level High, a falling reference waveform generation portion A17c obtains a voltage of REF_WF. The falling reference waveform generation portion A17c continues to obtain the voltage of the REF_WF until the control signal Tf reaches a level Low, and outputs the voltage as Tf_OUT. When the control signal Tf has reached the level Low, Tf_OUT falls with a fixed gradient from the REF_WF, and eventually becomes 0 V.

When the control signal Tr becomes the level High, a waveform switching portion A17d selects the reference waveform Tr_OUT which has been output from the rising reference waveform generation portion A17a, and outputs the reference waveform Tr_OUT. In FIG. 19, the control signal Tr is High in a period up to the time when the voltage of Tr_OUT reaches a level V4.

When the control signal Tr has reached the level Low, the waveform switching portion A17d selects LEVEL_OUT when the control signal Tf is the level High, and outputs the LEVEL_OUT. When the control signal Tf has reached the level Low, the waveform switching portion A17d selects Tf_OUT and outputs the Tf_OUT.

By the above described operation, the reference waveform REF_WF for an output waveform rises from the ground level with a fixed gradient, outputs a designated voltage level, and then falls down to the ground level with a fixed gradient.

### Operation Example 2

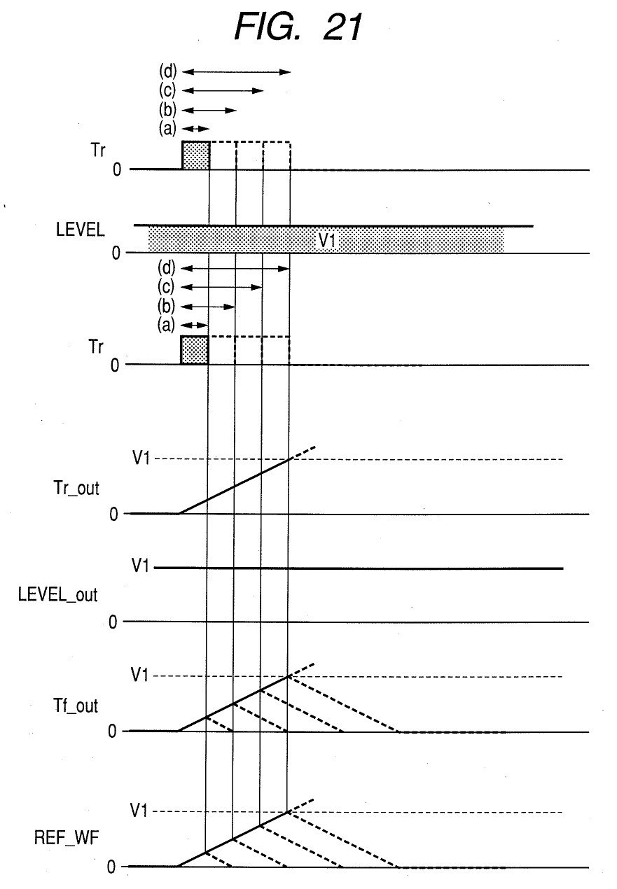

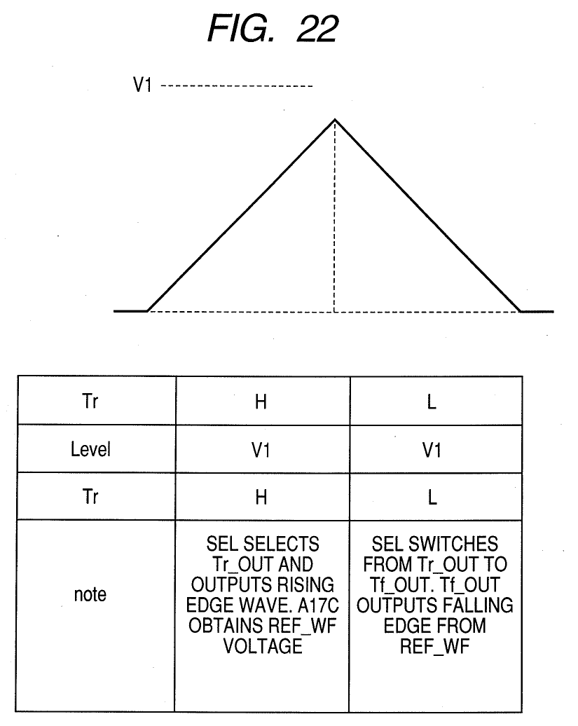

One example of an operation timing of an output circuit A15 will now be described with reference to FIG. 21 and FIG. 22. FIG. 21 is a timing chart illustrating Operation example 2 of the output circuit A15, and FIG. 22 is a logical table of Operation example 2.

It is a point different from that in Operation example 1 that Operation example 2 does not output a voltage level signal LEVEL_OUT having a fixed voltage but switches from a rising waveform immediately to a falling waveform. In other words, the modulation pulse in Operation example 1 was a trapezoidal waveform, but the modulation pulse in Operation example 2 is a triangular waveform. The triangular waveform can be used for driving a signal in a low gradation, for instance.

FIG. 21 illustrates an example of generating a triangular waveform in between 0 V and level V1.

As is understood from FIG. 21 and FIG. 22, a reference waveform REF_WF of a triangular waveform is generated by the operation in which both the control signal Tr and the control signal Tf are switched from a level High to a level Low at the same timing. The longer is a period of High of the control signals Tr and Tf, the larger can be the generated triangular waveform. In the example of FIG. 21, the length of the period of High is (a)>(b)>(c)>(d), and the peak of the triangular waveform reaches the level V1 when the length is (d).

In FIG. 21, an example of the triangular waveform in between 0 V and the level V1 was described, but the triangular waveform also in between other voltage levels can be output by appropriately setting the control signals Tr and Tf.

In the circuit structure according to the present exemplary embodiment, each output circuit A15 includes a rising reference waveform generation portion A17a, an output level generation portion A17b and a falling reference waveform generation portion A17c. Accordingly, each of the output circuits A15 for M pieces of pixels can independently control the rising timing of the modulation pulse, a voltage level and an output period thereof, and the falling timing of the modulation pulse. In other words, the output circuit may differentiate the rising timing and the falling timing of the modulation pulse from others, and may differentiate the voltage level from others for each pixel (each modulation wire).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-104646, filed Apr. 14, 2008, which is hereby incorporated by reference herein in its entirety.

What is claimed is:

1. An image display apparatus comprising:
a plurality of display elements; and
a drive circuit for driving the plurality of display elements, the drive circuit having a correction circuit for correcting, in response to a gradation, variations of luminance characteristics of the plurality of display elements,
wherein the drive circuit outputs modulation signals such that a modulation signal for a first gradation and a modulation signal for a second gradation are of similar shape, and
wherein the correction circuit corrects the first gradation using a value derived from an luminance characteristics of the display element that is measured by driving the display element with the modulation signal for the second gradation.

2. The image display apparatus according to claim 1, wherein the second gradation is greater than the first gradation.

3. The image display apparatus according to claim 1, wherein the modulation signals for the first and the second gradations are trapezoid.

4. The image display apparatus according to claim 1, wherein the modulation signals for the first and the second gradations are triangle.

5. The image display apparatus according to claim 4,
wherein the drive circuit outputs modulation signals such that a modulation signal for a third gradation and the modulation signal for the second gradation are not of similar shape, the third gradation being grater than the first and the second gradations, and
the modulation signal for the third gradation is trapezoid.

6. The image display apparatus according to claim 1, wherein the drive circuit drives the plurality of display elements in passive matrix.

7. The image display apparatus according to claim 1, wherein the display element comprises an electron-emitting device.
